(19) United States
(12) Patent Application Publication
(10) Pub. No.: US 2004/0143974 A1
(43) Pub. Date: Jul. 29, 2004

(54) Trimmer

(76) Inventors: Gian Andrea Giovanardi, Modena (IT); Pierluigi Sgarbi, Reggio Emilia (IT)

Correspondence Address: NATH & ASSOCIATES, PLLC, Sixth Floor, 1030 15th Street, N.W., Washington, DC, 20005, US

(21) Appl. No.: 10/700,061

(22) Filed: Nov. 4, 2003

(30) Foreign Application Priority Data
Nov. 5, 2002 (IT) B02002A 000698

(51) Int. Cl. B26B 7/00

(52) U.S. Cl. 30/276

(57) ABSTRACT

The trimmer has a motor; a tool head; an arm supporting the head; a propeller shaft inside the arm and angularly integral with a drive shaft of the motor; a bevel gear pair housed inside the head; and an adapter for making the propeller shaft and a hub of the bevel gear pair angularly integral.

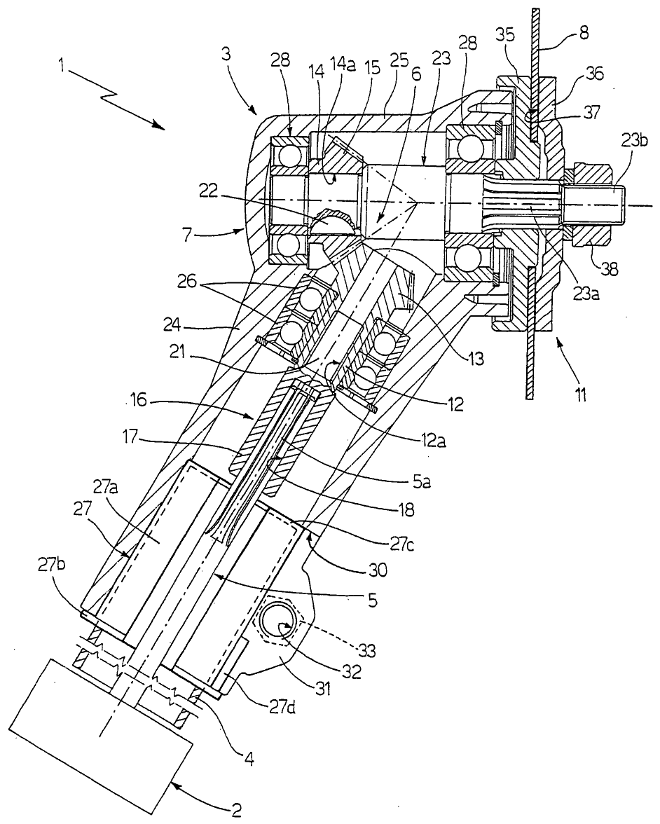

The present invention relates to an improved trimmer.

### BACKGROUND OF THE INVENTION

As is known, a trimmer is a garden implement for cutting grass or brush, and comprises a motor, a tool head, and an arm fitted at a first axial end to the motor casing, and supporting the head at a second axial end. The drive shaft powers the tool via a propeller shaft housed inside the arm, and via a bevel gear pair inside the head. More specifically, the bevel gear pair is defined by a hub engaged internally by one axial end of the propeller shaft, and having a first bevel gear at one axial end; and by a second bevel gear meshing with the first and fitted to a shaft extending inside the head and to which the tool is fitted. The head also comprises a casing fixed to the arm, and is so designed to reduce speed between the drive shaft and the tool, and to facilitate cutting by the tool. Trimmer manufacturers worldwide number about twenty, each of which produces at least six trimmer models, and, for each model, a different bevel gear pair, a different attachment between the head casing and the arm, and other component parts, so that at least a hundred different trimmer heads are currently available on the market. Moreover, the bevel gear pair is the part of the trimmer subject to most wear, so much so that it is normal practice to replace the head after a given work life, which may pose various problems. In particular, the head is also one of the most expensive parts of the trimmer, and for which no spares are available on the market, so that the user is forced to purchase an original head, and the retailer to stock, at understandable extra cost, a number of heads for various makes and models.

### SUMMARY OF THE INVENTION

It is an object of the present invention to provide a trimmer designed to eliminate the aforementioned drawbacks, i.e. featuring a head which can be adapted for use on a number of trimmers of different models and makes.

According to the present invention, there is provided a trimmer of the type comprising:

a motor;

a tool head;

a tubular arm fitted at a first axial end to the casing of said motor, and supporting said head at a second axial end;

a propeller shaft housed inside said arm and angularly integral with a drive shaft of said motor;

a bevel gear pair housed inside said head and defined by a first hub coaxial with said propeller shaft and having a first bevel gear, and by a second hub having a second bevel gear meshing with said first bevel gear; and

a tool shaft angularly integral with said second hub;

characterized by comprising a first adapter for making said first hub and said propeller shaft angularly integral.

### BRIEF DESCRIPTION OF THE DRAWING

The present invention will be described with reference to the accompanying drawing, which shows a section of a trimmer indicated as a whole by 1.

### DETAILED DESCRIPTION OF THE INVENTION

Trimmer 1 comprises a motor 2, a tool head 3, and a tubular arm 4 fitted (in known manner not shown) at a first axial end to the casing of motor 2, and supporting head 3 at a second axial end. Arm 4 is fitted coaxially inside with a propeller shaft 5, which, at a first axial end, is angularly integral (in known manner not shown) with a drive shaft (not shown) of motor 2, and, at a second axial end, has an externally splined portion 5a extending outside arm 4.

With reference to the accompanying drawing, head 3 comprises a bevel gear pair 6, a casing 7, a tool 8 (shown schematically), and connecting means 11 for attaching tool 8. Bevel gear pair 6 comprises a first hub 12 coaxial with shaft 5, and on which a first bevel gear 13 is formed in one piece; and a second hub 14, on which is formed in one piece a second bevel gear 15 meshing with first gear 13; an angle of substantially 60° being defined between the longitudinal axes of hubs 12 and 14. At a first axial end, hub 12 has a through axial hole 12a in which a threaded portion is formed; and, at a second axial end, hub 12 has gear 13. Hub 12 is connected angularly integral with shaft 5 by means of an adapter 16 having a first portion 17, in which is formed a splined dead hole 18 engaged by splined portion 5a of shaft 5, and an externally threaded second portion 21 screwed into the threaded portion of hole 12a of hub 12. Obviously, portion 5a may be engaged differently inside hole 18, e.g. by means of a key, square key, or other similar connecting systems. Hub 14 has a through axial hole 14a, at which hub 14 is fitted to a tool shaft 23 by means of a key 22.

With reference to the accompanying drawing, casing 7 comprises two tubular portions 24 and 25 formed in one piece and coaxial with hub 12 and hub 14 respectively. Portion 24 houses hub 12 by means of two ball bearings 26, also houses adapter 16, and is fixed by a second adapter 27 to said second axial end of arm 4. Portion 25 houses hub 14, and, by means of two ball bearings 28, also houses a large portion of tool shaft 23. Adapter 27 is defined by a tubular member 27a having an open lateral portion and which is fitted to said second axial end of arm 4. Tubular member 27a comprises, at a first axial end, an edge bent outwards to form a rim 27b on which the axial end edge of portion 24 of casing 7 rests, and, at a second axial end, an edge bent inwards to form a rim 27c which rests against the edge of the second axial end of arm 4.

With reference to the accompanying drawing, portion 24 of casing 7 is fitted by means of adapter 27 to said second axial end of arm 4. To effectively lock head 3 to arm 4, an axial opening 30 is formed in portion 24; and from the facing edges of opening 30 extend outwards two parallel tabs 31, each having a through hole 32 whose longitudinal axis lies in a plane perpendicular to the longitudinal axis of portion 24. One of holes 32 is threaded, and a bolt 33 fits first through the non-threaded hole 32 of one tab 31, and screws inside the threaded hole 32 of the other tab 31 to firmly grip the end portion of arm 4. A tab 27d extends outwards from tubular member 27a, and in particular inside the gap between tabs 31, and defines a locating member for assembly of adapter 27.

With reference to the accompanying drawing, tool shaft 23 comprises a portion extending outside tubular portion 25 of casing 7, and which comprises, in succession, a splined portion 23a and a threaded end portion 23b. Means 11 comprise two internally splined annular flanges 35, 36 fitted along splined portion 23a of shaft 23, and between which is defined an annular gap 37 for seating tool 8; and a nut 38 screwed to threaded portion 23b to grip tool 8 between flanges 35 and 36.

The numerous advantages of the present invention will be clear from the foregoing description.

In particular, a universal head 3 is obtained with a fixed bevel gear pair 6, and which can be fitted to any trimmer 1 using adapters 16 and 27, which, as shown, are straightforward in design and cheap to produce. Different trimmer models, in fact, substantially differ as regards the diameter of splined portion 5a of shaft 5, and the outside diameter of arm 4. Now it is possible to provide a number of adapters 16 differing solely in the diameter of hole 18, and a number of adapters 27 differing solely in inside diameter. In other words, retail stock is limited to a number of universal heads 3, and a number of adapters 16 and 27 by which to fit universal head 3 to any trimmer model, thus considerably reducing both the manufacturing and storage cost of spare heads and, consequently, consumer cost.

1) A trimmer of the type comprising:
a motor (2);
a tool head (3);
a tubular arm (4) fitted at a first axial end to the casing of said motor (2), and supporting said head (3) at a second axial end;
a propeller shaft (5) housed inside said arm (4) and angularly integral with a drive shaft of said motor (2);
a bevel gear pair (6) housed inside said head (3) and defined by a first hub (12) coaxial with said propeller shaft (5) and having a first bevel gear (13), and by a second hub (14) having a second bevel gear (15) meshing with said first bevel gear (13); and
a tool shaft (23) angularly integral with said second hub (14);
characterized by comprising a first adapter (16) for making said first hub (12) and said propeller shaft (5) angularly integral.

2) A trimmer as claimed in claim 1, characterized in that said first adapter (16) comprises a first portion (17) in which is formed a hole (18) engaged by a portion (5a) of said propeller shaft (5); and an externally threaded second portion (21) screwed inside a threaded hole (12a) formed in said first hub (12).

3) A trimmer as claimed in claim 1, characterized in that said head (3) comprises a casing (7) defined by two tubular portions (24, 25), of which a first tubular portion (24) is coaxial with said first hub (12), and a second tubular portion (25) is coaxial with said second hub (14); said second tubular portion housing said second hub (14) and a large portion of said tool shaft (23); said first tubular portion (24) housing said first hub (12) and said first adapter (16); and said first tubular portion (24) being fitted to said second axial end of said arm (4) by means of a second adapter (27).

4) A trimmer as claimed in claim 3, characterized in that said second adapter (27) is tubular, and is fitted to said second axial end of said arm (4).

5) A trimmer as claimed in claim 4, characterized in that said second adapter (27) comprises, at a first axial end, an edge bent outwards to form a rim (27b) on which the edge of the axial end of said first tubular portion (24) of said casing (7) rests, and comprises, at a second axial end, an edge bent inwards to form a rim (27c) which rests on the edge of said second axial end of said arm (4).

6) A trimmer as claimed in claim 3, characterized in that said second adapter (27) is defined by a laterally open tubular member (27a).

7) A trimmer as claimed in claim 3, characterized in that said first tubular portion (24) of said casing (7) has an axial opening (30), and from the facing edges of said opening (30) extend outwards two parallel tabs (31), each having a through hole (32), and one of which holes is threaded; a bolt (33) being fitted first through the non-threaded said hole (32) of a first tab (31), and then being screwed inside the threaded said hole (32) of the second tab (31) to firmly grip said second axial end of said arm (4).

8) A trimmer as claimed in claim 7, characterized in that an appendix (27d) extends outwards from said second adapter (27), and in particular inside the gap between said tabs (31), and is therefore gripped between said tabs (31).

9) A tool head for a trimmer, comprising:
a bevel gear pair (6) defined by a first hub (12) coaxial with a propeller shaft (5) and having a first bevel gear (13), and by a second hub (14) having a second bevel gear (15) meshing with said first bevel gear (13); and
a tool shaft (23) angularly integral with said second hub (14);
characterized by comprising a first adapter (16) for making said first hub (12) and said propeller shaft (5) angularly integral.

10) A tool head as claimed in claim 9, characterized by comprising a casing (7) defined by two tubular portions (24, 25), of which a first tubular portion (24) is coaxial with said first hub (12), and a second tubular portion (25) is coaxial with said second hub (14); said second tubular portion housing said second hub (14) and a large portion of said tool shaft (23); said first tubular portion (24) housing said first hub (12) and said first adapter (16); and said first tubular portion (24) being fitted, by means of a second adapter (27), to an axial end of an arm (4) housing said propeller shaft (5).
